(19) United States
(12) Patent Application Publication
(10) Pub. No.: US 2017/0061412 A1
(43) Pub. Date: Mar. 2, 2017

(54) METHOD AND A SYSTEM FOR CASHLESS TRANSACTION AND INVENTORY MANAGEMENT FOR VENDING MACHINES

(71) Applicant: AROON ASHISH KHATTER, Pune (IN)

(72) Inventor: AROON ASHISH KHATTER, Pune (IN)

(21) Appl. No.: 14/842,886

(22) Filed: Sep. 2, 2015

(51) Int. Cl. G06Q 20/18; G06Q 20/40; G06Q 20/32; G06Q 10/08; G06Q 20/20

(52) U.S. Cl. CPC G06Q 20/18; G06Q 10/087; G06Q 20/202; G06Q 20/3278; G06Q 20/401

(57) ABSTRACT

The invention relates to a method and a system for management of cashless purchase or transaction using a vending machine and software installed on a mobile device such as a smart phone. The present invention maintains security of payment by keeping confidentiality of payment and ensures that the code sent to the user/purchaser is used only once. The invention provides easy mode of purchase and transaction over a network managing both the user and the vending machine over a network and facilitates cashless transaction and eliminate cumbersome transactions by managing inventory.

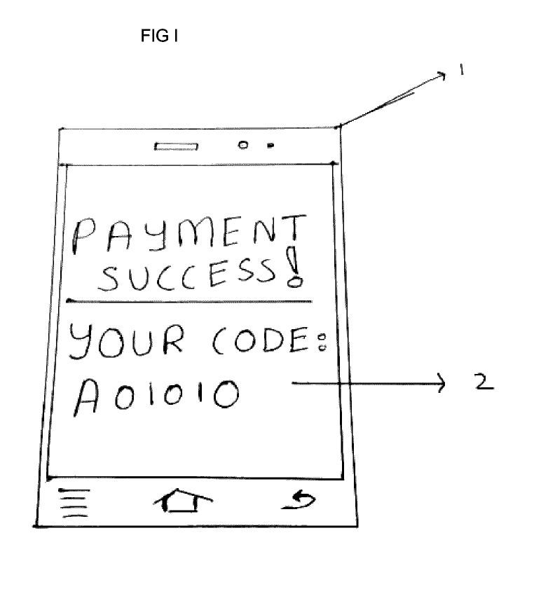

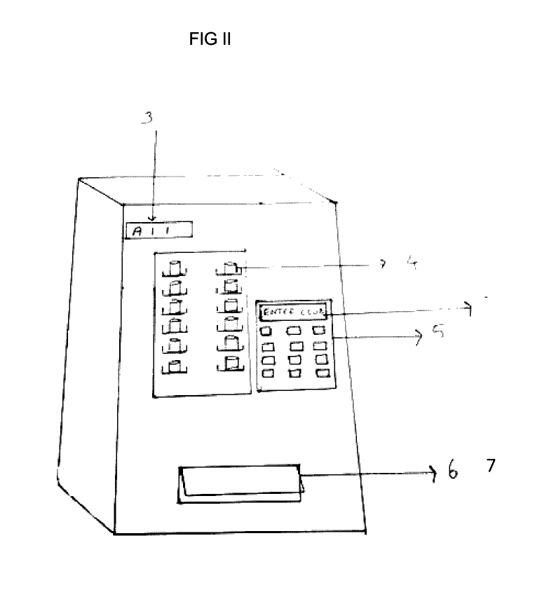

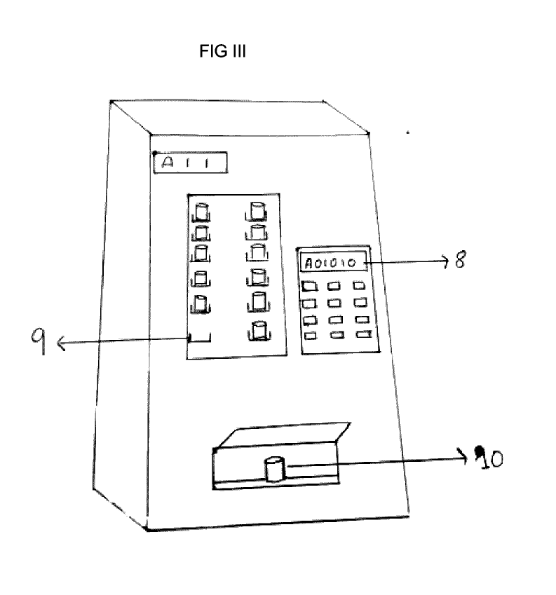

### BACKGROUND

Technical Field

The present invention relates to the management of purchase and transactions over a network through automated vending machines, and more particularly to wireless management of remote vending machines without internet connection.

Description of the Related Art

State-of-the-art explains purchase and selling of the products as a self service model wherein one has to pay at the vendor and take the item of interest on his own or in some cases where payment is done using credit card and/or debit card wherein you swipe a debit or a credit card at the vending machine and collect product on payment. One finds it galling to carry all the cards along with you every time you go shopping.

In some cases, the user device is connected to the vending machine through internet; moreover several vending machines are linked to the central server through internet for updating and/or managing the inventory. Thus offline inventory management is not possible in this case and both user device and the machine require internet connectivity. WO2014037923 explains the user and the machine both should be connected with internet.

nearby vending machine, the code is generated according to the inventory saved in the vending machine and is given to the user on making payment for said order made by the user. This also shows for which item which machine is selected as the number of the machine is given for particular item. After payment, when code is forwarded to the user and the user on displaying or entering the said code at the vending machine will receive the items or order purchased at a dispensing area.

The code generation is well shown in the logic of the payment system. The present invention can be described by way of example only. It is to be recognized that modifications falling within the scope and spirit of the description or claims, which would be obvious to a person skilled in the art based upon the disclosure herein, are also considered to be included within the scope of this disclosure.

### EXAMPLE

User and/or purchaser approaches vending machine marked with machine number A01. User who is also mentioned as purchaser in the specification has said application installed on the user device or a smart phone.

Said software application on the user device identifies nearby vending machine, say, A01 to the user. Based on user chosen machine A01, the software application accesses the database of available codes for Machine A01 from back-end software application on the central server, and displays it on the software application on the device of the user. The codes generated are pre-loaded (hard coded) into the software of each vending machine. The codes have pre-decided characters and digits in between A, 0, and 1 and generates code A X 0 P 1 5. Code is based on location and the location i.e. Machine A01 is in the 1^{st}, 3^{rd} and 5^{th} character of the code generated.

On approaching the vending machine, said user compares the located vending machine number suggested by said software application to that with the number displayed on the vending machine.

Code Example for Machine A01: A X 0 P 1 5

Front End of Software Application:

Once the user has identified the machine, he would choose the product on said software application and make the purchase through his digital wallet, debit/credit card, net banking or any means of digital payment or online transactions but not just limited to those mentioned. Once payment has been successfully carried out, the server generates a unique code based on user identified location of machine.

On entering the code A X 0 P 1 5 has been entered by the user in the machine, product will be dispensed from the machine.

Back-End of the Software Application:

Said software application at the central server identifies the machine based on 1^{st}, 3^{rd} and 5^{th} character of the code generated (A01=machine number).

Once purchase is made, software application, at the server, will automatically record the sale of one product from inventory levels of Machine A01. Said software application on the centralized server maintains the inventory and records every purchase made against it. Also said server updates the availability of the products to the user, on his device through said software application installed on said device.

Thus the link is created securely between the user, vending machine as well as centralized inventory management and/or server without the necessity of an internet connection at the vending machine.

I claim:

1. A cashless purchase or transaction system comprising;
a software wherein once loaded in the system of the user manages the transaction between the user and the vending machine,
a user device with the installed application,
a vending machine with installed software through which product is dispensed
a means for generating a unique verification code on payment.
a server or inventory management unit that links user device and vending machine.

2. A cashless purchase or transaction system as claimed in claim 1, wherein security of said payment is maintained by keeping payment confidential and also ensuring said code sent to the user/purchaser is used only once.

3. A cashless purchase or transaction system as claimed in claim 1, wherein said means for generating a unique code on completion of the payment is made on the server.

4. A cashless purchase or transaction system as claimed in claim 1, wherein said server or said inventory management unit maintains inventory at the vending machine on every purchase on the products at the inventory and updates the availability of products at the user end.

5. A cashless purchase or transaction system as claimed in claim 3, wherein said unique code is used to identify product in the inventory maintained at the vending machine.

6. A cashless purchase or transaction system as claimed in claim 3, wherein said unique code is generated only on payment of the order and serves as a receipt of payment.

7. A cashless purchase or transaction system claimed in claim 4, wherein said products in the inventory are recorded with an identification code and or number for each item and the purchase of every product is maintained at the server until the inventory is empty subsequently said numbering is refreshed on uploading new stock in the inventory.

8. A cashless purchase or transaction system as claimed in claim 6, wherein said receipt can be used at the software installed vending machine to collect the product.
